(19) United States
(12) Patent Application Publication
(10) Pub. No.: US 2003/0167457 A1
(43) Pub. Date: Sep. 4, 2003

(54) System and method for providing an optimizer display tool

(76) Inventors: Carol L. Thompson, San Jose, CA (US); Cary A. Coutant, Saratoga, CA (US)

Correspondence Address: HEWLETT-PACKARD COMPANY, Intellectual Property Administration, P.O. Box 272400, Fort Collins, CO, 80527-2400, US

(21) Appl. No.: 10/087,407

(22) Filed: Mar. 1, 2002

(51) Int. Cl. G06F 9/44; G06F 9/45

(52) U.S. Cl. 717/109; 717/160

(57) ABSTRACT

The present invention provides a system and method for providing a graphic representation of code characteristic and optimizations performed. In architecture, the system includes an optimizer display tool that indicates at least one instruction characteristic in a program and comprises logic that acquires a block of code in the program, and logic for analyzing the block of code for the at least one instruction characteristic. The optimizer display tool further comprises logic for generating a unique graphical indicator for the at least one instruction characteristic, and logic for displaying the unique graphical indicator with the block of code to indicate that the at least one instruction characteristic is present in the block of code.

The present invention can also be viewed as providing a method for providing a graphic representation of code characteristic and optimizations performed. In this regard, the preferred method can be broadly summarized by the following steps: (1) acquiring a block of code in a program; (2) analyzing the block of code for at least one instruction characteristic; (3) generating a unique graphical indicator for the at least one instruction characteristic; and (4) displaying the unique graphical indicator with the block of code to indicate that the at least one instruction characteristic is present in the block of code.

### FIELD OF THE INVENTION

The present disclosure relates to systems and methods for debugging computer programs. More particularly, the disclosure relates to an optimizer display tool for producing graphic representations of code characteristics and optimizations that are performed to enhance programmer understanding of code behavior.

### BACKGROUND OF THE INVENTION

An increasing number of executable machine codes (i.e., binaries) are being generated by compilers which incorporate advanced optimization techniques in order to fully utilize many of the current high-speed data processors. With this increased number of executable machine codes being generated, it is becoming a necessity to provide a clear, correct and effective way for programmers to debug and visualize the highly optimized code. There are a couple of aspects of code optimization that make debugging of optimized machine code difficult.

First, optimization complicates the mapping between source code and machine code. This is due to code duplication, elimination, and re-ordering caused by the optimization. Second, when optimizations are performed, they generally destroy the simple source-to-object correlation present in un-optimized code. Thus, when inspecting an optimized program being debugged, it is generally very difficult to identify the exact location in the machine code. Moreover, since variables may live at different locations at different points in the program, reporting variable values becomes much more complicated.

In addition, because the optimized code reorders, eliminates and duplicates code, it is much more difficult for a programmer to analyze the optimized code to provide further optimization.

Furthermore, the optimization process performs significant program analysis that could potentially provide useful information to the programmer, but is currently unavailable. The useful information includes, but is not limited to: 1) better understand the behavior of their program; 2) improve the performance by enabling more or better optimizations; and 3) identify potential defects in their code.

Thus, a heretofore-unaddressed need exists in the industry to address these and/or other inefficiencies and inadequacies of computer software.

### SUMMARY OF THE INVENTION

The present disclosure relates to systems and methods for providing graphic representations of code characteristics and optimizations performed. Briefly described, in architecture, an embodiment of the system includes an optimizer display tool that indicates at least one instruction characteristic in a program. The optimizer display tool comprises logic that acquires a block of code in the program, and logic for analyzing the block of code for the at least one instruction characteristic. The optimizer display tool further comprises logic for generating a unique graphical indicator for the at least one instruction characteristic, and logic for displaying the unique graphical indicator with the block of code to indicate that the at least one instruction characteristic is present in the block of code.

The present invention can also be viewed as a method for providing a graphic representation of code characteristics and optimizations performed. In this regard, the method can be broadly summarized by the following: (1) acquiring a block of code in a program; (2) analyzing the block of code for at least one instruction characteristic; (3) generating a unique graphical indicator for the at least one instruction characteristic; and (4) displaying the unique graphical indicator with the block of code to indicate that the at least one instruction characteristic is present in the block of code.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating an example of a computer system showing a compiler optimizer with a debugger system and the optimizer display tool within a memory area.

FIG. 2 is a block diagram illustrating an example of the process flow that utilizes the optimizer display tool of the present invention, as shown in FIG. 1.

FIG. 3 is a flow chart illustrating functionality of an example of the optimizer display tool utilizing the compiler/optimizer generated optimized code in conjunction with a debug process as shown in FIGS. 1 and 2.

FIG. 4 is a flow chart illustrating functionality of an example of the optimizer display tool of the present invention, as shown in FIGS. 1-3, utilizing the compiler/optimizer and debug information as shown in FIGS. 2 and 3.

FIG. 5 is a flow chart illustrating functionality of the sub-statement process utilized in the optimizer display tool of the present invention, as shown in FIGS. 1-4.

FIG. 6 is a flow chart illustrating functionality of the loop entry process utilized in the optimizer display tool of the present invention as shown in FIGS. 1-4.

FIG. 7 is a flow chart illustrating functionality of the loop body process utilized by the optimizer display tool of the present invention as shown in FIGS. 1-4.

FIG. 8 is a flow chart illustrating functionality of the dead code process utilized in the optimizer display tool of the present invention as shown in FIGS. 1-4.

FIG. 9 is a flow chart illustrating functionality of the data-speculative load process utilized in the optimizer display tool of the present invention as shown in FIGS. 1-4.

FIG. 10 is a block diagram illustrating an example of the display information generated by the optimizer display tool of the present invention as shown in FIGS. 1-4.

### DETAILED DESCRIPTION

Referring now in more detail to the drawings, in which like numerals indicate corresponding parts throughout the several views, the present invention will be described. While the invention is described in connection with these drawings, there is no intent to limit it to the embodiment or embodiments disclosed therein. On the contrary, the intent is to cover all alternatives, modifications, and equivalents included within the spirit and scope of the invention as defined by the appended claims.

The present invention relates to an optimizer display tool for utilizing debug information that is generated for the purpose of debugging optimized code. The optimizer display tool is used in order to convey information to a developer/programmer about the characteristics of the optimized code and the optimizations that have been performed.

The display tool may be incorporated into other software development tools, such as a debugger, or it may be operated as a separate stand-alone tool, both of which utilize the debug information to identify a number of optimization conditions. These conditions are variable and the optimizer display tool is selectable, so that the developer/programmer can be shown the data about those code transformations that are of interest to them.

The potential benefits of the optimizer display tool include providing additional information to the developer/programmer about the nature of their program code. This may allow the developer/programmer to restructure the optimized code or insert compiler pragmas in order to improve performance. In addition, the marking of common sub-expressions in the code, as well as dead code, may assist a developer/programmer in identifying defects in the program code.

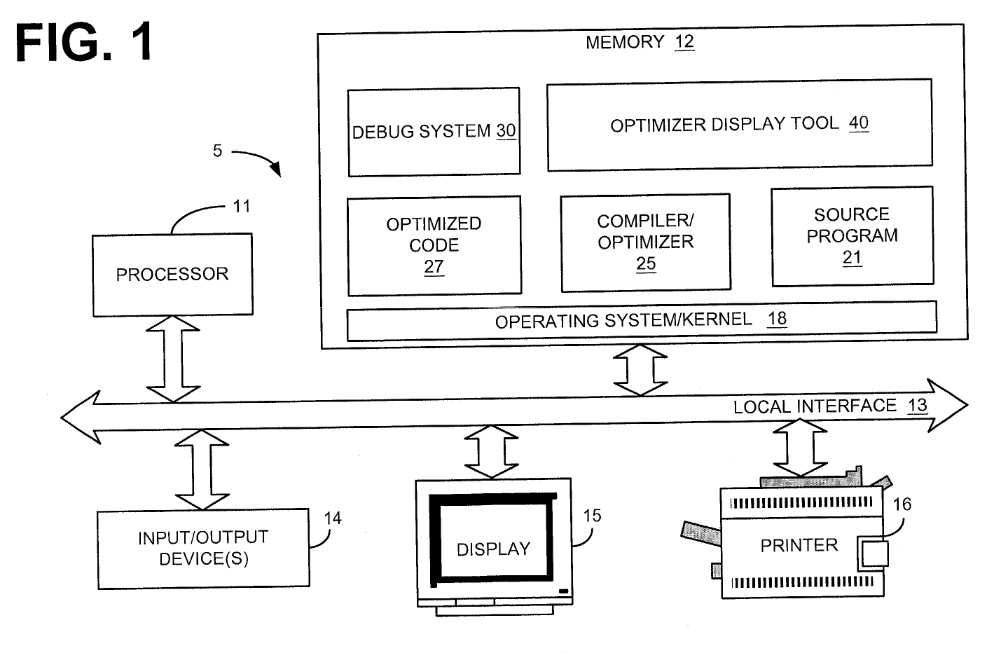

Turning now to the drawings, FIG. 1 is a block diagram example of a general-purpose computer that can implement the optimizer display tool. Generally, in terms of hardware architecture, as shown in FIG. 1, the computer 5 includes a processor 11, memory 12, and one or more input devices and/or output (I/O) devices (or peripherals) that are communicatively coupled via a local interface 13. The local interface 13 can be, for example but not limited to, one or more buses or other wired or wireless connections, as is known in the art. The local interface 13 may have additional elements, which are omitted for simplicity, such as controllers, buffers (caches), drivers, repeaters, and receivers, to enable communications. Further, the local interface 13 may include address, control, and/or data connections to enable appropriate communications among the aforementioned components.

The processor 11 is a hardware device for executing software that can be stored in memory 12. The processor 11 can be virtually any custom made or commercially available processor, a central processing unit (CPU) or an auxiliary processor among several processors associated with the computer 5, and a semiconductor based microprocessor (in the form of a microchip) or a macroprocessor. Examples of suitable commercially available microprocessors are as follows: an 80×86, Pentium, or Itanium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 12 can include any one or combination of volatile memory elements (e.g., random access memory (RAM, such as DRAM, SRAM, etc.)) and nonvolatile memory elements (e.g., ROM, hard drive, tape, CDROM, etc.). Moreover, the memory 12 may incorporate electronic, magnetic, optical, and/or other types of storage media. Note that the memory 12 can have a distributed architecture, where various components are situated remote from one another, but can be accessed by the processor 11.

The software in memory 12 may include one or more separate programs, each of which comprises an ordered listing of executable instructions for implementing logical functions. In the example of FIG. 1, the software in the memory 12 includes an operating system 18, a source program code 21, a debug system 30, the optimizer display tool 40, a compiler/optimizer 25, and optimized code 27 utilized by the optimizer display tool 40 of the present invention.

A non-exhaustive list of examples of suitable commercially available operating systems 18 are as follows: a Windows operating system from Microsoft Corporation, U.S.A., a Netware operating system available from Novell, Inc., U.S.A., an operating system available from IBM, Inc., U.S.A., any LINUX operating system available from many vendors or a UNIX operating system, which is available for purchase from many vendors, such as Hewlett-Packard Company, U.S.A., Sun Microsystems, Inc. and AT&T Corporation, U.S.A. The operating system 18 essentially controls the execution of other computer programs, such as the optimizer display tool 40, and provides scheduling, input-output control, file and data management, memory management, and communication control and related services.

The optimizer display tool 40 and the debug system 30 may be a source programs, executable programs (object code), script, or any other entity comprising a set of instructions to be performed. When a source program, then the program is usually translated via a compiler 25, assembler, interpreter, or the like, which may or may not be included within the memory 12, so as to operate properly in connection with the O/S 18. Furthermore, the optimizer display tool 40 and the debug system 30 can be written as (a) an object oriented programming language, which has classes of data and methods, or (b) a procedure programming language, which has routines, subroutines, and/or functions, for example but not limited to, C, C++, Pascal, BASIC, FORTRAN, COBOL, Perl, Java, and Ada.

The I/O devices 14 may include input devices, for example but not limited to, a keyboard, mouse, scanner, microphone, etc. Furthermore, the I/O devices 14 may also include output devices, for example but not limited to, a printer 16, display 15, etc. Finally, the I/O devices 14 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 5 is a PC, workstation, or the like, the software in the memory 12 may further include a basic input output system (BIOS) (omitted for simplicity). The BIOS is a set of essential software routines that initialize and test hardware at startup, start the O/S 18, and support the transfer of data among the hardware devices. The BIOS is stored in ROM so that the BIOS can be executed when the computer 5 is activated.

When the computer 5 is in operation, the processor 11 is configured to execute software stored within the memory 12, to communicate data to and from the memory 12, and to generally control operations of the computer 5 pursuant to the software. The optimizer display tool 40, debug system 30, the compiler 25 and the O/S 18 are read, in whole or in part, by the processor 11, perhaps buffered within the processor 11, and then executed.

When the optimizer display tool 40, debug system 30 and the compiler 25 are implemented in software, as is shown in FIG. 1, it should be noted that can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method. The optimizer display tool 40, debug system 30 and the compiler 25 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where optimizer display tool 40 is implemented in hardware, the optimizer display tool 40 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

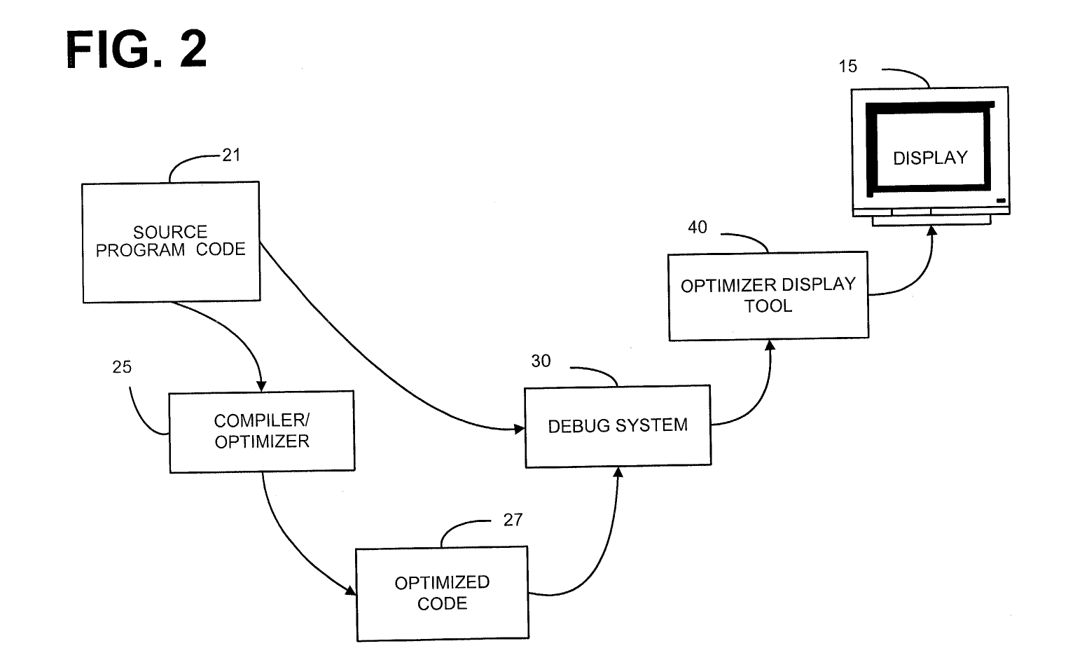

Illustrated in FIG. 2 is a block diagram illustrating an example of a process flow that can be used to produce a graphical representation of optimized code characteristics and optimization performed to enhance developer/programmer understanding of code behavior. First, the source program 21 is input into a program compiler/optimizer 25 for processing. The compiler/optimizer 25 then generates optimized code 27 that includes executable machine instructions for representation of the source program code 21. The optimized code 27 and a copy of the original source program code 21 are then both input into an optional debug system 30.

The optional debug system 30 is utilized to communicate the debug information for the optimized code to the user. This debug information can be utilized to convey information to a developer about the characteristics of the code and the optimizations that have been performed. An example of one debug system that organizes debug information is described in a commonly assigned U.S. Pat. No. 6,263,489 entitled “Method and Apparatus for Debugging of Optimized Code”, filed on Apr. 30, 1998, which is herein incorporated entirely by reference.

After utilizing the optional debugged system 30 to organize and convey debug information, the optimized code 27 and source program code 21 from the optional debug system 30 are provided to the optimizer display tool 40 of the present invention. The optimizer display tool 40 generates graphical representations of code characteristics and optimizations that have been performed in order to provide additional information to a developer/programmer about the nature of the code. These graphical representations may allow the developer/programmer to restructure their source program code 21 or insert compiler pragmas, in order to improve the program performance. In addition, markings can be used to indicate common sub-expressions and dead code in order to assist the developer/programmer in identifying potential problems in source program code 21.

The graphical representation of code characteristics and the optimizations performed are then displayed on the display 15 (FIG. 1) for presentation to the developer/programmer. In alternative embodiments, the graphical representation of code characteristics and the optimizations performed can be printed on the printer 16 (FIG. 1) for presentation to the developer/programmer, or saved to memory 12 (FIG. 1) for later access.

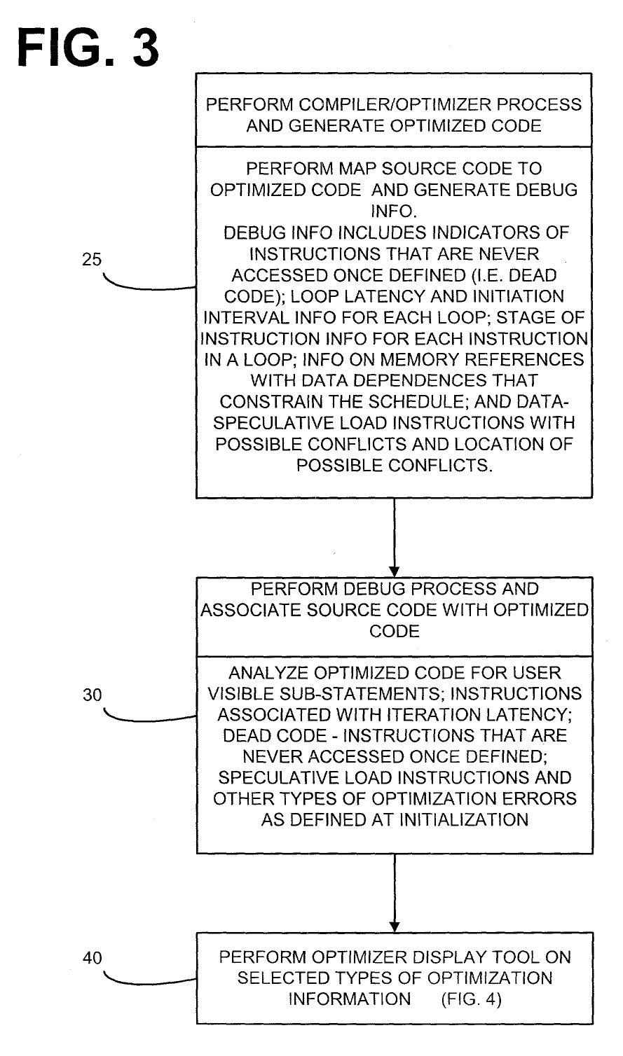

Illustrated in FIG. 3 is a flow chart illustrating functionality of an example using the optimizer display tool 40 of the present invention as shown in FIGS. 1 and 2. The first step in the process is to perform the compiler/optimizer process 25 and generate optimized code 27 (FIGS. 1 and 2). While performing the compiler/optimizer process 25 in generating the optimized code 27, the compiler/optimizer process 25 performs a map to the source code 21 (FIGS. 1 and 2) with the optimized code 27 to generate debug information. This debug information includes indications of instructions that are never accessed once defined (i.e., dead code), loop latency and initiation interval information for each loop, stage of instruction for each of the instructions within the loop, information on memory references with reference dependencies that constrain the schedule, and the data-speculative load instructions with possible conflicts and locations of those possible conflicts. It should be recognized that data-speculative loads are sometimes called “advanced loads”.

Next, the optional debug system 30 performs a debug operation and associates the source code 21 with the optimized code 27. The optional debug system 30 also analyzes the optimized code 27 for user visible sub-statements, instructions associated with loops, dead code instructions that are never accessed once defined, data-speculative load instructions and other types of optimization characteristics as defined in the initialization of the optional debug system 30.

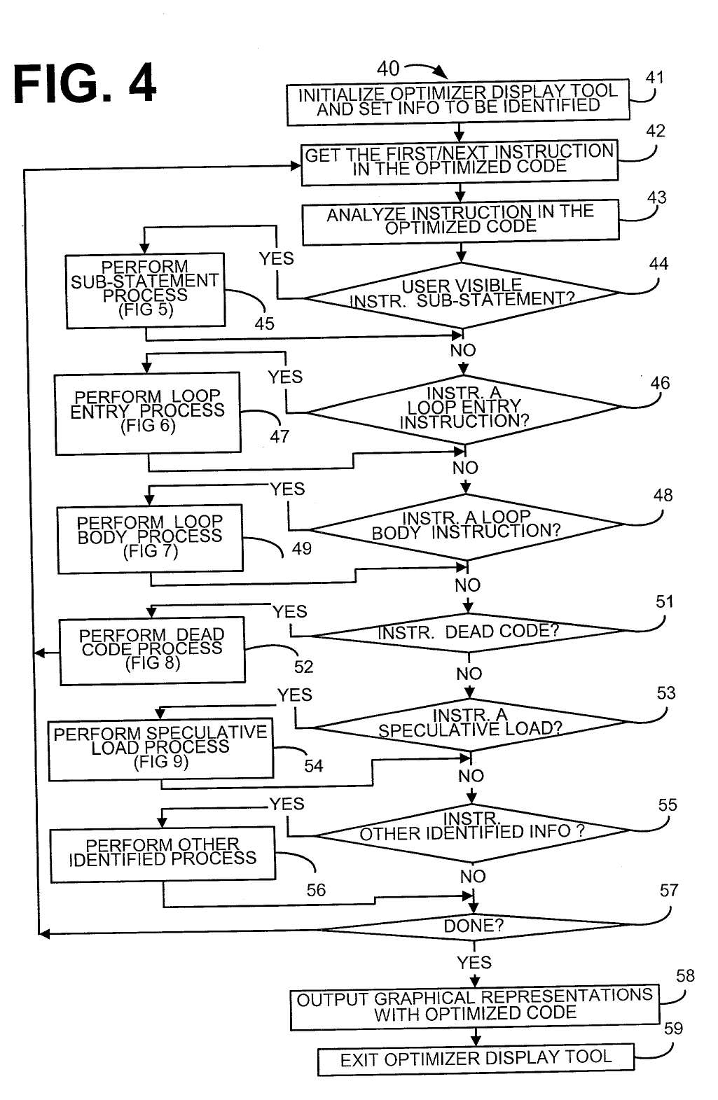

After mapping the source code 21 with the optimized code 27, the optimizer display tool 40 then generates a graphical representation of selected types of optimization information. The optimizer display tool 40 is herein defined in further detail with regard to FIG. 4. The generated graphical representation of code characteristics and the optimizations can then be displayed for presentation to the developer/programmer. In alternative embodiments, the graphical representation of code characteristics and the optimizations performed can be printed, or saved to memory for later access.

Illustrated in FIG. 4 is a flow chart illustrating functionality of an embodiment of an optimizer display tool 40 of the present invention. The optimizer display tool 40 is used in order to identify and convey information to a developer/programmer about the characteristics of the optimized code 27 (FIGS. 1 and 2) and the optimizations that have been performed.

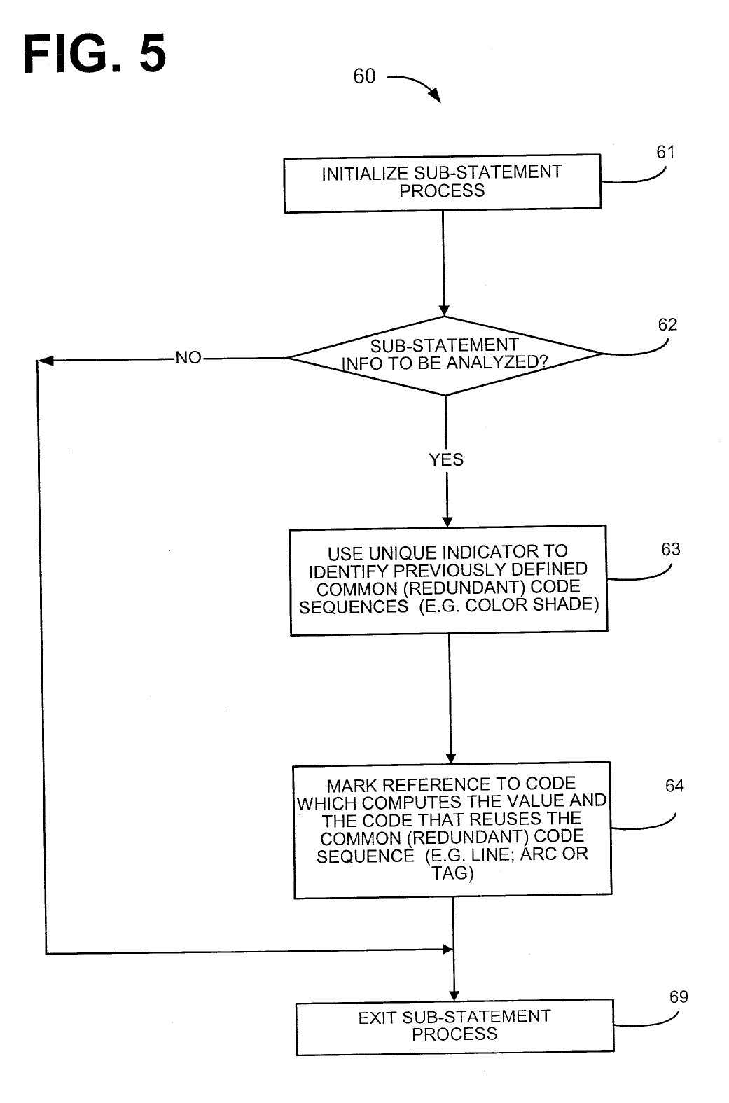

First, the optimizer display tool 40 is initialized at step 41 and sets the information to be identified. The information to be identified can be set with default setting or by the developer/programmer to the requested optimizations to be analyzed. At step 42, the first or next instruction in the optimized code is obtained. Analysis of the instruction obtained at step 42 is then performed at step 43. At step 44, the optimizer display tool 40 determines if the instruction is a user-visible sub-statement. If it is determined at step 44 that the current instruction is a user-visible sub-statement, then the optimizer display tool 40 then performs the sub-statement process at step 45. The sub-statement process is herein defined in further detail with regard to FIG. 5.

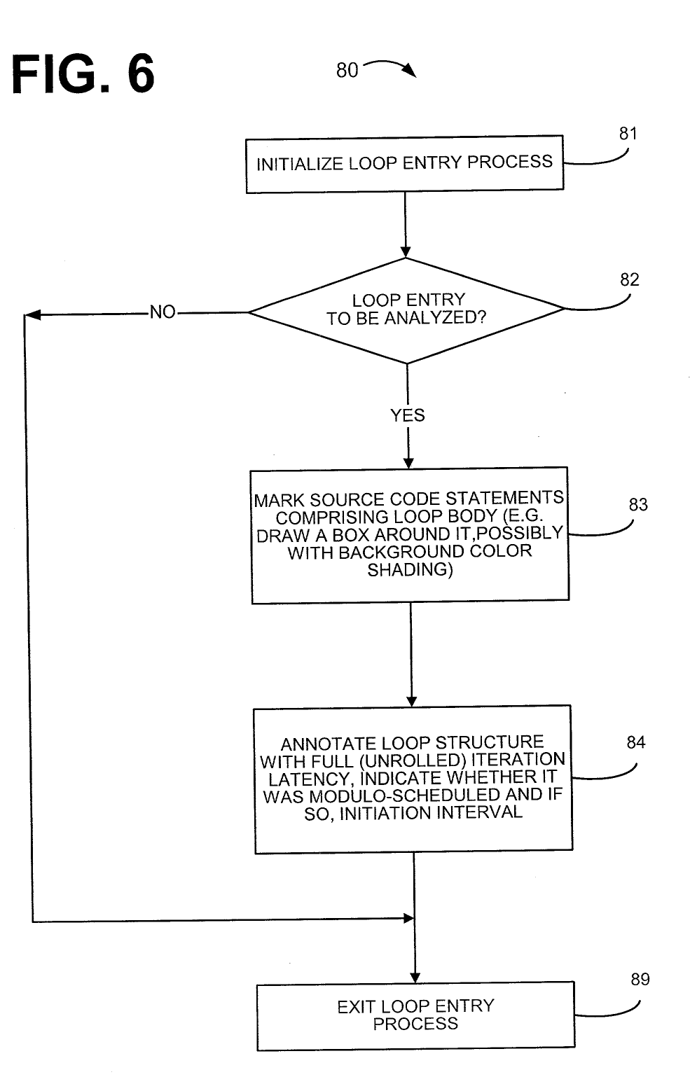

Next, the optimizer display tool 40 determines if the current instruction is a loop entry instruction at step 46. If it is determined at step 46 that the current instruction is a loop entry instruction, then the optimizer display tool 40 then performs the loop entry process at step 47. The loop entry process is herein defined in further detail with regard to FIG. 6.

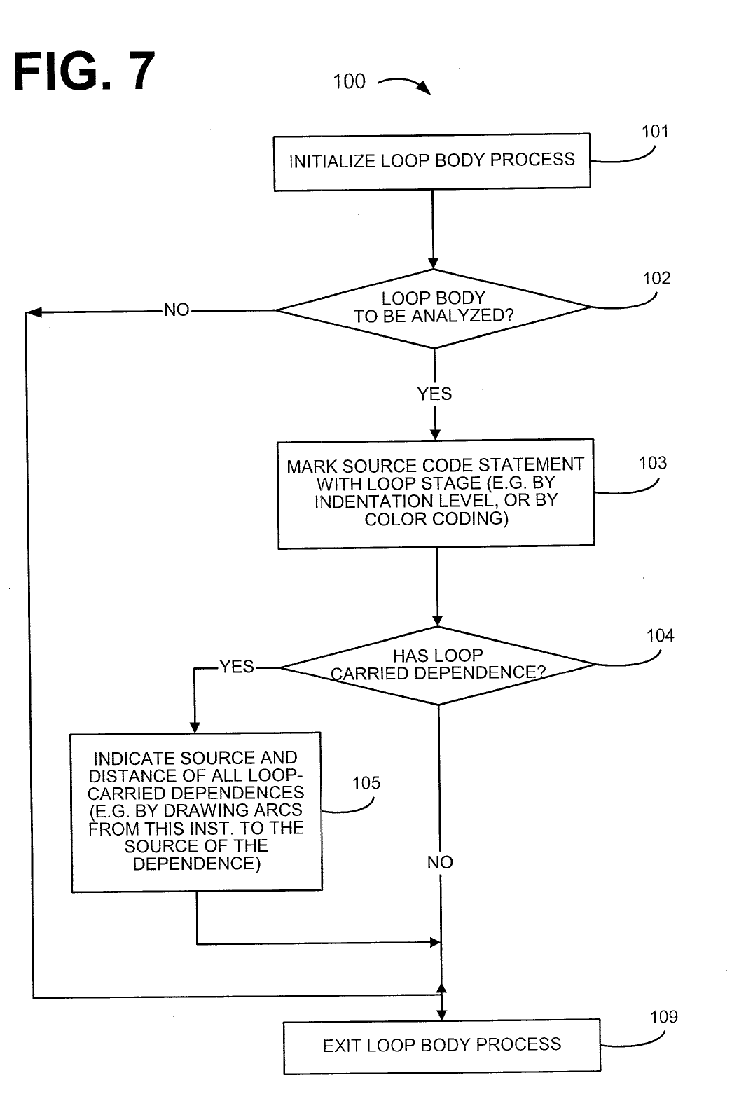

At step 48, the optimizer display tool 40 determines if the current instruction is a loop body instruction. If it is determined at step 48 that the current instruction is a loop body instruction, then the optimizer display tool 40 then performs the loop body process in step 49. The loop body process is herein defined in further detail with regard to FIG. 7.

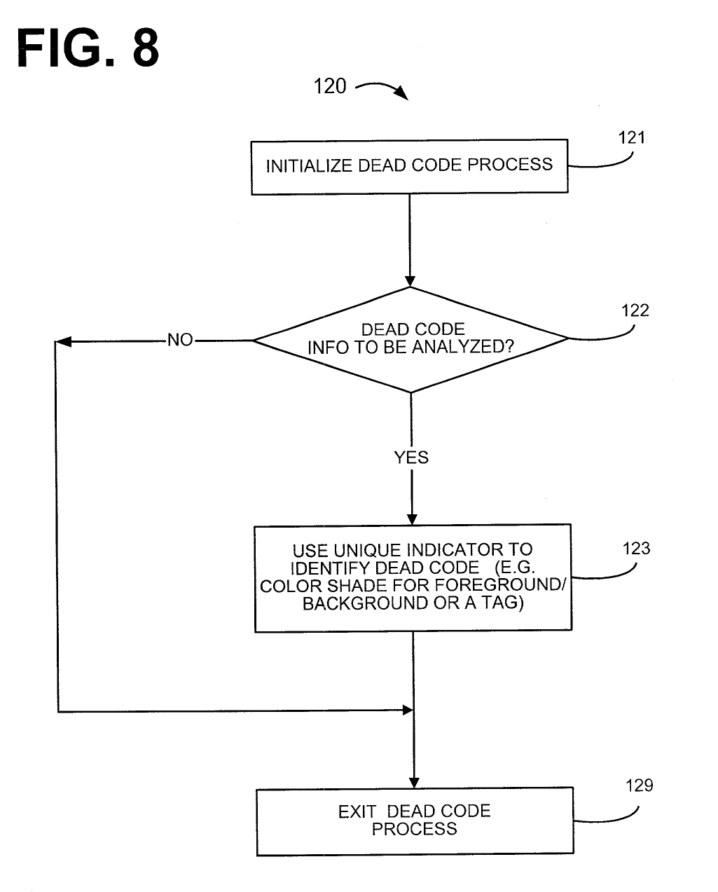

Next, the optimizer display tool 40 determines if the current instruction is dead at step 51. If it is determined at step 51 that the current instruction is dead code, then the optimizer display tool 40 then performs the dead code process at step 52. The dead code process is herein defined in further detail with regard to FIG. 8. After performing the dead code process at step 52, the optimizer display tool 41 then returns to step 42 to get the next instruction in the optimized code and make it the current instruction for analysis.

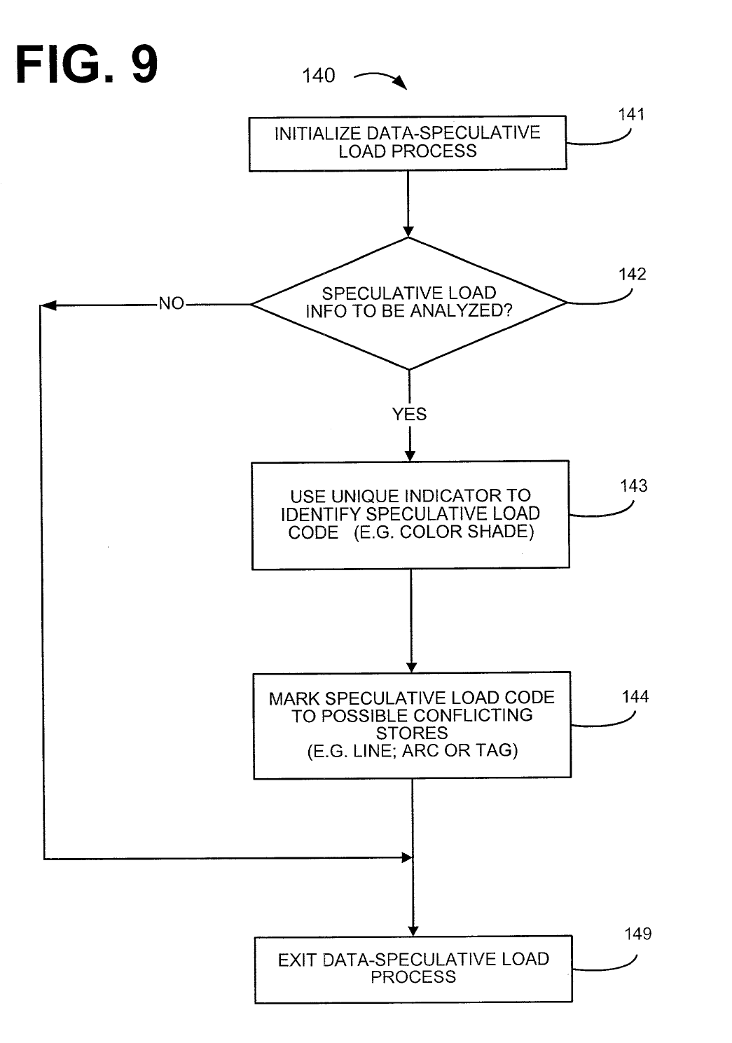

However, if it is determined in step 51 that the current instruction is not dead code, then the optimizer display tool 40 determines if the current instruction is a data-speculative load at step 53. If it is determined at step 53 that the current instruction is a data-speculative load, then the optimizer display tool 40 then performs the data-speculative load process at step 54. The data-speculative load process is herein defined in further detail with regard to FIG. 9.

Next, the optimizer display tool 40 determines if the instruction is some other type of pre-identified instruction in which information is collected at step 55. If it is determined that the current instruction is another identified instruction, then the optimizer display tool 40 then performs the other identified process at step 56.

Next, the optimizer display tool 40 determines if there are more instructions in the optimized code to be analyzed at step 57. If it is determined that there are more instructions in the optimized code to be analyzed, then the optimizer display tool 40 then returns to repeat steps 42-57. However, if it is determined at step 57 that there are no more instructions in the optimized code for analysis, then the optimizer display tool 40 outputs the graphical representations with optimized code at step 48 and exits at step 49. The graphical representation of code characteristics and the optimizations performed can be output to the display 15 (FIG. 1) for presentation to the developer/programmer. In alternative embodiments, the graphical representation of code characteristics and the optimizations performed can be printed on the printer 16 (FIG. 1) for presentation to the developer/programmer, or saved to memory 12 (FIG. 1) for later access.

Illustrated in FIG. 5 is a flow chart illustrating the preferred functionality of the sub-statement process 60 that is within the optimizer display tool 40 of the present invention. The sub-statement process 60 is used to identify and mark previously defined, common (i.e. redundant) code sequences.

First, the sub-statement process 60 is initialized at step 61. In step 62, the sub-statement process 60 then determines if sub-statement information is to be analyzed. If it is determined at step 62 that sub-statement information is not to be analyzed, then the initialized sub-statement process 60 skips to step 69 to exit the sub-statement process without performing any analysis of the current instruction in the optimized code.

However, if it is determined at step 62 that sub-statement information is to be analyzed as part of the selected information identified at step 41 (FIG. 4), then the sub-statement process 60 uses a unique indicator to identify previously defined, common, (i.e. redundant) code sequences at step 63. This unique indicator can be for example, but is not limited to, arrows, tags, color highlighting and the like. Next, at step 64, the sub-statement process 60 marks the reference to code which computes the value and the code that re-uses the common, i.e., redundant code sequence. The references can be marked utilizing a number of techniques including, but not limited to, arrows, tags, color highlights, or the like. The sub-statement process 60 then exits at step 69.

Illustrated in FIG. 6 is a flow chart illustrating a preferred functionality of the loop entry process 80 that is in the optimizer display tool 40 of the present invention. The loop entry process 80 is used to identify and mark loop entry instructions.

First, the loop entry process 80 is initialized at step 81. Next, the loop entry process 80 determines if the current instruction is a loop entry instruction at step 82. If it is determined at step 82 that the current instruction is not a loop entry instruction, then the loop entry process 80 then skips to step 89 to exit the loop entry process.

However, if it determined at step 82 that the current instruction is a loop entry instruction, then the loop entry process 80 marks the source code statements comprising the loop body at step 83. This marking can be, for example, but not limited to, a box drawn around it or possible background color shading to indicate the code being within the loop associated with the current loop entry. At step 84, the loop entry process 80 then annotates the loop structure with the latency for a fully unrolled iteration. This annotation indicates whether it was a modulo-scheduled loop and if so the initiation interval of the modular scheduled loop. The loop entry process 80 then exits at step 89.

Illustrated in FIG. 7 is a flow chart illustrating the preferred functionality of an example of the loop body process 100 that is within the optimizer display tool 40 of the present invention. The loop body process 100 is used to identify and mark loop stages and loop carried dependencies.

First, the loop body process 100 is initialized at step 101. At step 102, it is determined if a loop body information is to be analyzed. If it is determined at step 102 that loop body information is not to be analyzed, the loop body process 100 then skips and exits at step 109.

However, if it is determined at step 102 that loop body information is to be analyzed, then the loop body process 100 marks the source code statement with its loop stage. An example of a loop stage annotation may be for example, but is not limited to, an indentation by increasing indentation amount for each loop stage, or by color coding or the like. Next, at step 104, the loop body process 100 determines if the instruction has any loop-carried dependencies. If it is determined at step 104 that the instruction does not have any loop-carried dependencies, then the loop body process 100 exits at step 109.

However, if it is determined at step 104 that the current instruction does have loop-carried dependencies, then the loop body process 100 indicates the source and distance of all the loop carried dependencies. The loop carried dependencies may be illustrated by, for example, but not limited to, drawing arcs from the current instruction to the sources of the dependencies. After indicating the source and distance of all loop carried dependencies, the loop body process 100 then exits at step 109.

Illustrated in FIG. 8 is a flow chart illustrating the preferred functionality of an example of the dead code process 120 that is within the optimizer display tool 40 of the present invention. The dead code process 120 is used to identify and mark dead code (i.e. code that can never be executed).

First, the dead code process is initialized at step 121. Next, the dead code process 120 then determines if dead code information is to be analyzed at step 122. If it is determined at step 122 that dead code information is not to be analyzed, then the dead code process 120 then skips and exits at 129.

However, if it is determined at step 122 that dead code information is to be analyzed, then the dead code process 120 uses a unique identifier to shade the dead code. This unique indicator may be, for example, but is not limited to, color shade for foreground/background, a tag or the like. After identifying the dead code at step 123, the dead code process 120 then exits at step 129.

Shown in FIG. 9 is a flow chart illustrating the preferred functionality of an example of the data-speculative load process 140 within the optimizer display tool 40 of the present invention. The data-speculative load process 140 is used to identify and mark data-speculative load code with possible conflicting stores.

First, the data-speculative load process 140 is initialized at step 141. At step 142, the data-speculative load process determines if data-speculative load information is to be analyzed. If it is determined at step 142 that data-speculative load information is not to be analyzed, then the data-speculative load process 140 then skips and exits at step 149.

However, if it is determined at step 142 that data-speculative load information is to be analyzed, then the data-speculative load process 140 uses a unique indicator to identify the data-speculative load code at step 143. The data-speculative load code indicator can be for example, but is not limited to, color shading, color tags or the like. Next, at step 144, the data-speculative load process 140 associates the data-speculative load code with possible conflicting stores. An example of the association of possible conflicting stores is provided by a line, mark or tag. After marking the possible conflict stores at step 144, the data-speculative load process load 140 then exits at step 149.

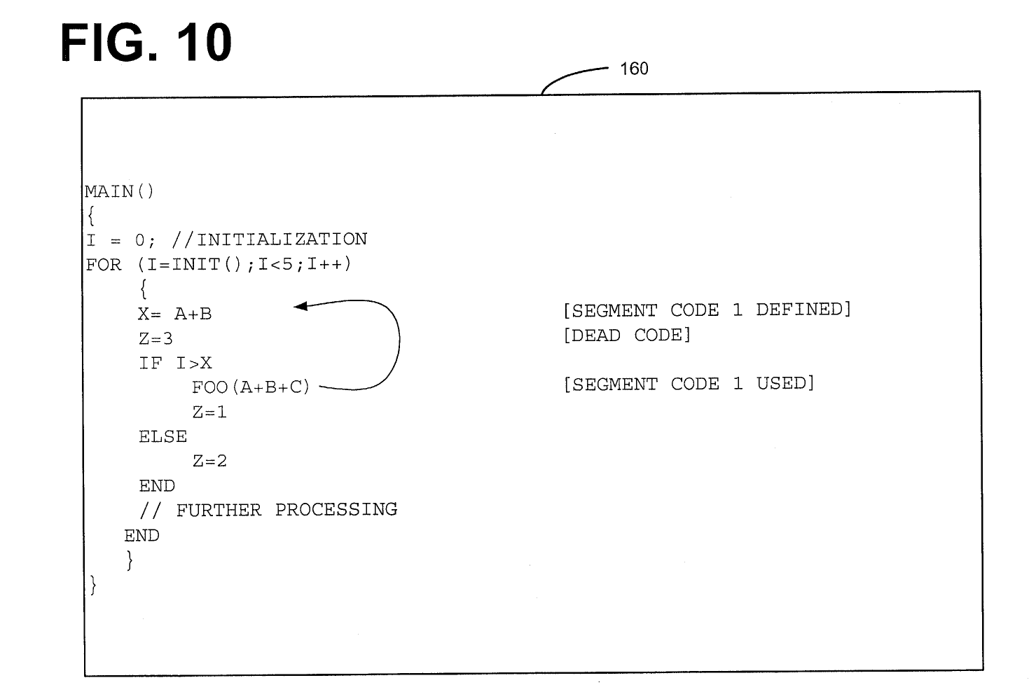

Illustrated in FIG. 10 is a block diagram illustrating an example of the display information 160 generated by the optimizer display tool 40 of the present invention as shown in FIGS. 1-4. The example of the display information 160 of the graphical representation of the code characteristics and optimizations, which have been performed, may be displayed on display 15 (FIG. 1) or in a printout on printer 16 (FIG. 1).

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for providing a graphic representation of code characteristics, the method comprising:
acquiring a block of code in a program;
analyzing the block of code for at least one instruction characteristic;
generating a unique graphical indicator for the at least one instruction characteristic; and
displaying the unique graphical indicator with the block of code to indicate that the at least one instruction characteristic is present in the block of code.

2. The method of claim 1, wherein the at least one code characteristic is selected from the group consisting of a user-visible sub-statement instruction, a loop entry instruction, a loop body instruction, dead code instruction, and a data-speculative load instruction.

3. The method of claim 1, wherein the unique graphical indicator is selected from the group consisting of text color, background color, a line, an arc, a box and a tag.

4. The method of claim 1, wherein the displaying the unique graphical indicator step further comprises:
indicating if the at least one instruction characteristic is a loop-carried dependency.

5. The method of claim 1, wherein the displaying the unique graphical indicator step further comprises:
indicating if the at least one instruction characteristic is a data-speculative load instruction with at least one possible conflicting store.

6. A system for providing a graphic representation of code characteristics, comprising:
means for acquiring a block of code in a program;
means for analyzing the block of code for at least one instruction characteristic;
means for generating a unique graphical indicator for the at least one instruction characteristic; and
means for displaying the unique graphical indicator with the block of code to indicate that the at least one instruction characteristic is present in the block of code.

7. The system of claim 6, wherein the at least one code characteristic is selected from the group consisting of a user-visible sub-statement instruction, a loop entry instruction, a loop body instruction, dead code instruction, and a data-speculative load instruction.

8. The system of claim 6, wherein the unique graphical indicator is selected from the group consisting of text color, background color, a line, an arc, a box and a tag.

9. The system of claim 6, wherein the displaying means further comprises:
means for indicating if the at least one instruction characteristic is a loop-carried dependency.

10. The system of claim 6, wherein the displaying means further comprises:
means for indicating if the at least one instruction characteristic is a data-speculative load instruction with at least one possible conflicting store.

11. A computer readable medium for a graphic representation of code characteristics, comprising:
logic for acquiring a block of code in a program;
logic for analyzing the block of code for at least one instruction characteristic;
logic for generating a unique graphical indicator for the at least one instruction characteristic; and
logic for displaying the unique graphical indicator with the block of code to indicate that the at least one instruction characteristic is present in the block of code.

12. The computer readable medium of claim 11, wherein the at least one code characteristic is selected from the group consisting of a user-visible sub-statement instruction, a loop entry instruction, a loop body instruction, dead code instruction, and a data-speculative load instruction.

13. The computer readable medium of claim 11, wherein the unique graphical indicator is selected from the group consisting of text color, background color, a line, an arc, a box and a tag.

14. The computer readable medium of claim 11, wherein the displaying logic further comprises:
logic for indicating if the at least one instruction characteristic is a loop-carried dependency.

15. The computer readable medium of claim 11, wherein the displaying logic further comprises:
logic for indicating if the at least one instruction characteristic is a data-speculative load instruction with at least one possible conflicting store.

16. A system for providing a graphic representation of code characteristics, comprising:
a debug tool that indicates instruction characteristics in a program, wherein the debug tool further comprises:
logic for acquiring a block of code in the program;
logic for analyzing the block of code for the at least one instruction characteristic;
logic for generating a unique graphical indicator for the at least one instruction characteristic; and
logic for displaying the unique graphical indicator with the block of code to indicate that the at least one instruction characteristic is present in the block of code.

17. The system of claim 16, wherein the at least one code characteristic is selected from the group consisting of a user-visible sub-statement instruction, a loop entry instruction, a loop body instruction, dead code instruction, and a data-speculative load instruction.

18. The system of claim 16, wherein the unique graphical indicator is selected from the group consisting of text color, background color, a line, an arc, a box and a tag.

19. The system of claim 16, wherein the displaying logic further comprises:
logic for indicating if the at least one instruction characteristic is a loop-carried dependency.

20. The system of claim 16, wherein the displaying logic further comprises:
logic for indicating if the at least one instruction characteristic is a data-speculative load instruction with at least one possible conflicting store.
